(19) United States
(12) Patent Application Publication
(10) Pub. No.: US 2015/0168959 A1
(43) Pub. Date: Jun. 18, 2015

(54) FLOW CONTROL VALVE AND FLOW CONTROL SYSTEM USING SAME

(71) Applicant: ADVANCE DENKI KOGYO KABUSHIKI KAISHA, Kasugai-shi (JP)

(72) Inventor: Kimihito Sasao, Kasugai-shi (JP)

(21) Appl. No.: 14/518,200

(22) Filed: Oct. 20, 2014

(30) Foreign Application Priority Data
Dec. 13, 2013 (JP) 2013-258182

(51) Int. Cl. G05D 16/10; F16K 15/14; F16K 31/122; F16K 31/124

(52) U.S. Cl. CPC G05D 16/103; F16K 31/1245; F16K 15/145; F16K 31/1221

(57) ABSTRACT

A flow control valve is provided with an inflow side block which is provided with a main inflow part, an inflow side chamber, and an intermediate outflow part, an outflow side block which is provided with en intermediate inflow part, an outflow side chamber, a valve seat, and a main outflow part, a connection block which connects the inflow side block and the outflow side block, a connection flow path which connects the intermediate outflow part and the intermediate inflow part, a pressure differential device part, a first diaphragm to which a constant pressure is applied at all times, and a second diaphragm which is provided with a valve element which operates to advance and retract with respect to a valve seat, the connection block has a connection chamber, holds a transmission member which can transmit fluctuation of one diaphragm to the other.

### BACKGROUND OF THE INVENTION

1. Field of the Invention

The present invention relates to a flow control valve and to a flow control system which uses the same, more particularly relates to a flow control valve which is provided with a function of enabling stabilization at a predetermined fluid flow amount (flow rate) or of stabilization of the fluid flow amount after change and to a flow control system which is provided with that flow control valve.

2. Description of the Related Art

In the process of production of semiconductors, the surface of a silicon wafer (substrate) is cleaned by a diluted chemical. This is aimed at removing particles and metal contaminants, oxide films, etc. A treatment solution which is obtained by mixing a plurality of types of chemicals and pure water by a suitable ratio is used. For the treatment solution, APM (ammonia peroxide mixture, containing ammonium hydroxide, hydrogen peroxide, and pure water), HPM (hydrochloric/peroxide mixture, containing hydrochloric acid, hydrogen peroxide, and pure water), DHF (dilute hydrofluoric acid, containing hydrofluoric acid and pure water), SPM (sulfuric/peroxide mixture, containing sulfuric acid and hydrogen peroxide), etc. may be mentioned. For example, when this cleaning treatment is performed at a single wafer type system, the treatment solution etc. are supplied to the surface of a spinning wafer which is held horizontally.

In single wafer type cleaning systems, there are a cabinet type where the mixed treatment solution is stored in a tank and the treatment solution is supplied to the wafer and an in-line mixing type where a treatment solution which is mixed in right before the wafer is directly supplied. Such a latter system has a fluid mixing part. Pipes through which a high concentration chemical (concentrate) and pure water flow are connected to it, whereby a mixed solution is prepared. In a single wafer type system which treats one wafer at a time, the mixed solution which is supplied to the wafer surface is small in amount. When using the in-line type, the chemical which is supplied to the mixing part is small in amount. For example, if producing DHF, the ratio of flow amounts of hydrofluoric acid and pure water is 1:100. If the flow amount of pure water is set to 2.0 liter/min, the flow amount of hydrofluoric acid required becomes 0.02 liter/min. In treatment requiring control of such a fine amount of chemical, a slight change in the flow amount ends up causing a large difference in the cleaning effect. For this reason, constant flow valves which can supply a mixing part with a chemical and pure water with a high precision become necessary.

Further, in semiconductor production, larger scale integration and finer processing are being pursued. In the International Technology Roadmap for Semiconductors (ITRS), achievement of a 24 nm process is targeted for 2014. The target figure which is expressed by this process (24 nm) is defined as half of the narrowest pitch of lines at the bottommost layer in an MPU (line width+line interval) (half pitch). With a line width set in this way, fine contaminants (particles) enter the flow path of the fluid in the semiconductor production process and have a large effect on the product yield. The particles have to be made one-quarter of the line pitch (in the case of the process for 2014, 12 nm) or less. Members which maintain the cleanliness of the fluid while causing it to flow have great meaning.

In the constant flow valve which is disclosed in U.S. Pat. No. 6,805,156B2, a plurality of diaphragms which are arranged coaxially are configured so as to move together with respect to the pressure of the controlled fluid. At a valve seat, which is present at an inflow part side, a valve element which moves together with the diaphragms operates to open and close the valve. Due to these, the differential pressure in the constant flow valve is adjusted whereby the amount of outflow of the controlled fluid can be controlled to a predetermined flow amount. Further, the flow structure keeps the controlled fluid from pooling, enables the differential structure to be simply adjusted, and enables good response.

However, when controlling flow in the range of small flow amounts (flow rates), it is necessary to make the valve element advance and retract by a slight valve lift (opening degree). In such a constant flow valve, a plurality of diaphragms are linked by a shaft part, and the shaft part is inserted to the inside of the flow path at which the valve seat is formed. For this reason, operation of the valve element at the time of control is liable to cause the valve seat and valve element to slide against each other.

In the flow control system which is disclosed in US 2007/0056640A1, when a change of pressure occurs at the primary side fluid, the first pressure control valve part enables the secondary side of the first pressure control valve part to be maintained at the predetermined pressure and the flow amount to be controlled. On the other hand, if pressure fluctuation occurs at the secondary side fluid, the second pressure control valve part enables the primary side of the second pressure control valve part to be maintained at the predetermined pressure and the flow amount to be controlled. Therefore, even if a change of pressure occurs at the primary side or secondary side of the flow control system, it is possible to realize stabilization of the fluid flow amount at a high precision.

However, in the above flow control system, if the outflow of fluid is stopped etc. at the secondary side, the fluid pressure inside the flow control system will rise. At that time, the first pressure control valve part is liable to rapidly close, whereby the valve element is liable to strongly strike the valve seat of the first pressure control valve part.

In a conventional constant flow valve or flow control system, due to the above such operations, there is a concern over the possibility of the valve seat and the valve element etc. unexpectedly contacting and generating small particles. For this reason, a device is sought which can supply fluid by a fine flow amount at a high precision and which can maintain a high cleanliness.

Furthermore, if it were possible to satisfy the above demands and change a setting to a desired flow amount and possible to maintain a constant flow amount even after the above change, there could be progress in consolidation of devices. In particular, if there were a device which realized a constant flow amount in the range of small flow amounts and control of the flow amount itself, the feed of fluid could be made even easier to manage than before and, further, the cleanliness of the fluid could be maintained better. Therefore, a new device which realizes a constant flow amount of fluid and control of the flow amount itself all together has been demanded.

As related art, see the above U.S. Pat. No. 6,805,156B2 (corresponding to Japanese Patent No. 4022438 and EP 1321841B1) and US 2007/0056640A1 (corresponding to Japanese Patent Publication No. 2007-102754A).

### SUMMARY OF THE INVENTION

The present invention was made in consideration of this point and provides a flow control valve which suppresses unanticipated contact between a valve seat and valve element etc. to maintain a constant flow amount (flow rate) in a state with a higher cleanliness of the fluid and provides a flow control system which uses the same.

That is, the aspect of the invention of claim 1 provides a flow control valve which is provided with: an inflow side block which is provided with a main inflow part of a controlled fluid, an inflow side chamber which is connected to the main inflow part, and an intermediate outflow part which is connected to the inflow side chamber, an outflow side block which is provided with an intermediate inflow part, an outflow side chamber which is connected to the intermediate inflow part, a valve seat which is formed at the outflow side chamber, and a main outflow part of the controlled fluid which is connected to the outflow side chamber, a connection block which connects the inflow side block and the outflow side block, and a connection flow path which connects the intermediate outflow part and the intermediate inflow part, wherein at least at one of the inflow side chamber, the outflow side chamber, and the connection flow path is provided with a pressure differential device part, the inflow side block and the connection block have a first diaphragm interposed between them, the first diaphragm is arranged at the inflow side chamber, divides the inflow side chamber into a first chamber which contacts the controlled fluid and a second chamber which becomes the back surface side of the first chamber and does not contact the controlled fluid, and receives the fluid pressure in the first chamber and is pressed to the first chamber side by a biasing means by a constant pressure at all times, the outflow side block and the connection block have a second diaphragm interposed between them, the second diaphragm is arranged at the outflow side chamber, divides the outflow side chamber into a third chamber which contacts the controlled fluid and a fourth chamber which becomes the back surface side of the third chamber and does not contact the controlled fluid, and receives the fluid pressure in the third chamber and is provided with a valve element which advances and retracts with respect to the valve seat, the connection block has a connection chamber which runs from the second chamber to the fourth chamber, the connection chamber holding a transmission member which engages with the first diaphragm and the second diaphragm to transmit fluctuation of one diaphragm to the other diaphragm, and advancing and retracting motion of the first diaphragm and the second diaphragm due to pressure fluctuation before and after the pressure differential device part causes the valve element to advance and retract with respect to the valve seat to hold the flow amount of the controlled fluid constant.

The aspect of the invention of claim 2 provides the flow control valve according to claim 1 wherein the biasing means is a spring.

The aspect of the invention of claim 3 provides the flow control valve according to claim 1 wherein the biasing means is pneumatic air.

The aspect of the invention of claim 4 provides the flow control valve according to claim 1 wherein the pressure differential device part is a variable orifice.

The aspect of the invention of claim 5 provides the flow control valve according to claim 1 wherein the connection flow path is provided with a flow detecting part.

The aspect of the invention of claim 6 provides a flow control system which is provided with the flow control valve according to claim 1, a flow detecting part of a controlled fluid, and a processing part and where the pressure differential device part of the flow control valve is a variable orifice, wherein the flow control valve is connected to a fluid pipe between a feed part of the controlled fluid and a fluid mixing part of the controlled fluid and a control part which generates a signal which controls the variable orifice of the flow control valve is provided.

The aspect of the invention of claim 7 provides the flow control system according to claim 6 wherein the processing part performs feedback control based on a measured value of the flow amount of the flow detecting part.

### Advantageous Effects of Invention

According to the flow control valve according to claim 1, there is provided a flow control valve which is provided with: an inflow side block which is provided with a main inflow part of a controlled fluid, an inflow side chamber which is connected to the main inflow part, and an intermediate outflow part which is connected to the inflow side chamber, an outflow side block which is provided with an intermediate inflow part, an outflow side chamber which is connected to the intermediate inflow part, a valve seat which is formed at the outflow side chamber, and a main outflow part of the controlled fluid which is connected to the outflow side chamber, a connection block which connects the inflow side block and the outflow side block, and a connection flow path which connects the intermediate outflow part and the intermediate inflow part, wherein at least at one of the inflow side chamber, the outflow side chamber, and the connection flow path is provided with a pressure differential device part, the inflow side block and the connection block have a first diaphragm interposed between them, the first diaphragm is arranged at the inflow side chamber, divides the inflow side chamber into a first chamber which contacts the controlled fluid and a second chamber which becomes the back surface side of the first chamber and does not contact the controlled fluid, and receives the fluid pressure in the first chamber and is pressed to the first chamber side by a biasing means by a constant pressure at all times, the outflow side block and the connection block have a second diaphragm interposed between them, the second diaphragm is arranged at the outflow side chamber, divides the outflow side chamber into a third chamber which contacts the controlled fluid and a fourth chamber which becomes the back surface side of the third chamber and does not contact the controlled fluid, and receives the fluid pressure in the third chamber and is provided with a valve element which advances and retracts with respect to the valve seat, the connection block has a connection chamber which runs from the second chamber to the fourth chamber, the connection chamber holding a transmission member which engages with the first diaphragm and the second diaphragm to transmit fluctuation of one diaphragm to the other diaphragm, and advancing and retracting motion of the first diaphragm and the second diaphragm due to pressure fluctuation before and after the pressure differential device part causes the valve element to advance and retract with respect to the valve seat to hold the flow amount of the controlled fluid constant, so it is possible to suppress unanticipated contact between the valve seat and the valve element etc. to maintain a constant flow amount in a state of a higher cleanliness of the fluid.

According to the flow control valve according to claim 2, there is provided the aspect of the invention of claim 1 wherein the biasing means is a spring, so it is possible to press against the first diaphragm by an inexpensive and simple configuration.

According to the flow control valve according to claim 3, there is provided the aspect of the invention of claim 1 wherein the biasing means is pneumatic air, so it is possible to suitably change the pressing action against the first diaphragm to the first chamber side in accordance with the feed pressure of the pneumatic air.

According to the flow control valve according to claim 4, there is provided the aspect of the invention of claim 1 wherein the pressure differential device part is a variable orifice, so it is possible to change the flow coefficient relatively easily and possible to variably adjust a broader flow region.

According to the flow control valve according to claim 5, there is provided the aspect of the invention of claim 1 wherein the connection flow path is provided with a flow detecting part, so it is possible to make use of the piping of the connection flow path to simplify the pipeline layout.

According to the flow control valve according to claim 6, there is provided a flow control system which is provided with the flow control valve according to claim 1, a flow detecting part of a controlled fluid, and a processing part and where the pressure differential device part of the flow control valve is a variable orifice, wherein the flow control valve is connected to a fluid pipe between a feed part of the controlled fluid and a fluid mixing part of the controlled fluid and a control part which generates a signal which controls the variable orifice of the flow control valve is provided, so the number of members which contact the controlled fluid is suppressed and the cleanliness of the controlled fluid is easily maintained.

According to the flow control valve according to claim 7, there is provided the aspect of the invention of claim 6 wherein the processing part performs feedback control based on a measured value of the flow amount of the flow detecting part, so it is possible to immediately respond to changes in the flow amount caused at the secondary side (downstream side) of the flow control valve so as to change the flow amount of the controlled fluid and make the control fluid circulate by a constant flow amount at all times.

### BRIEF DESCRIPTION OF THE DRAWINGS

FIG. 1 is a vertical cross-sectional view of a flow control valve according to a first embodiment,

FIG. 2 is a vertical cross-sectional view of a state where a valve element of the first embodiment has advanced,

FIG. 3 is a vertical cross-sectional view of a state where the valve element of the first embodiment has retracted,

FIG. 4 is a vertical cross-sectional view of a flow control valve according to a second embodiment of the present invention,

FIG. 5 is a vertical cross-sectional view of a flow control valve according to a third embodiment of the present invention,

FIG. 6 is a vertical cross-sectional view of a flow control valve according to a fourth embodiment of the present invention,

FIG. 7 is a vertical cross-sectional view of a flow control valve according to a fifth embodiment of the present invention, and

FIG. 8 is a schematic view of a substrate treatment system in which a flow control system of the present invention is incorporated.

### DESCRIPTION OF THE PREFERRED EMBODIMENTS

Flow control valves 101, 102, 103, 104, and 105 of different embodiments which are explained and illustrated in the present invention are mainly arranged in fluid pipelines of semiconductor production plants, semiconductor production systems, etc. and are used for control of the flow of fluids. Specifically, the flow control valves are valves which are provided with the functions of realizing constant flow amounts (flow rates) of flow of ultrapure water which is used for cleaning silicon wafers etc. and hydrofluoric acid, hydrogen peroxide solution, ammonia water, hydrochloric acid, and other chemicals which are used for various types of treatment.

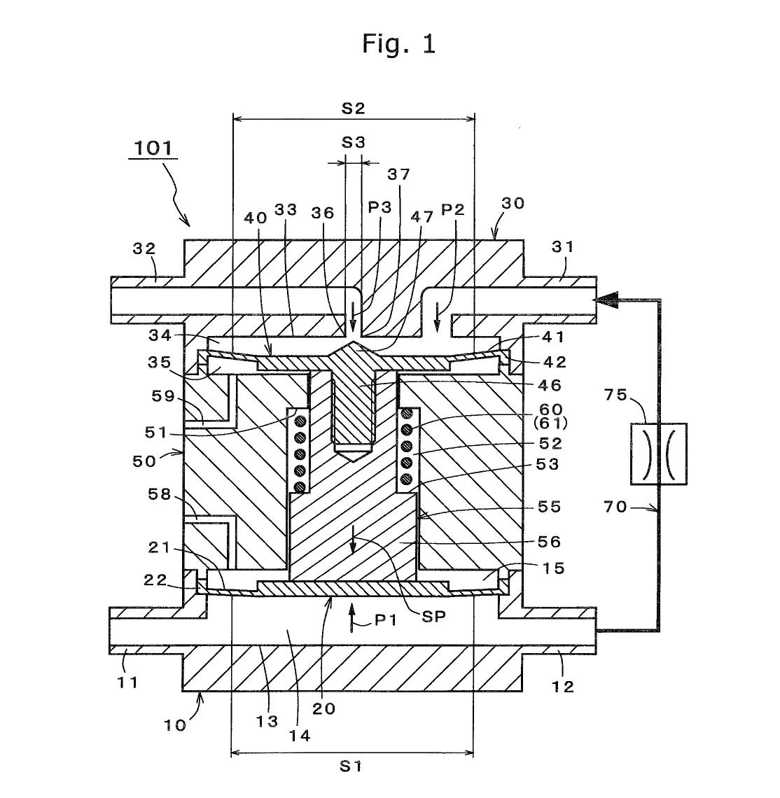

Based on the vertical cross-sectional view of FIG. 1, the structure of a flow control valve 101 of a first embodiment will be explained to start with. The flow control valve 101 is comprised of a combination of three blocks. At the side where the controlled fluid flows into the flow control valve 101, an inflow side block 10 is arranged, while at the side where the controlled fluid flows out from the flow control valve 101, an outflow side block 30 is arranged. Further, a connection block 50 which connects the inflow side block 10 and the outflow side block 30 is provided. The inflow side block 10, connection block 50, and outflow side block 30 are combined in that order.

At the inflow side block 10, a main inflow part 11 of the controlled fluid, an inflow side chamber 13 which is connected to the main inflow part 11, and an intermediate outflow part 12 which is connected to this inflow side chamber 13 is provided. At the outflow side block 30, an intermediate inflow part 31 to which the controlled fluid which flows out from the intermediate outflow part 12 of the inflow side block 10 flows, an outflow side chamber 33 which is connected to the intermediate inflow part 31, a valve seat 37 which is formed at the outflow side chamber 33, and a main outflow part 32 of the controlled fluid which is connected to the outflow side chamber 33 are provided.

In the flow control valve 101, a connection flow path 70 which connects the intermediate outflow part 12 and the intermediate inflow part 31 is provided. The controlled fluid which flows into the inflow side chamber 13 of the inflow side block 10 leaves the intermediate outflow part 12 and passes through the connection flow path 70. Further, it flows into the outflow side chamber 33 of the outflow side block 30. Further, in the illustrated example, a pressure differential device part 75 (orifice part or venturi part) is provided at the connection flow path 70 from among the inflow side chamber 13, outflow side chamber 33, and connection flow path 70.

The connection block 50 is arranged between the inflow side block 10 and the outflow side block 30 and connects the two blocks 10 and 30 together. The first diaphragm 20 which forms the inflow side of the controlled fluid is interposed between the inflow side block 10 and the connection block 50. At the first diaphragm 20, a thin movable film part 21 which becomes the diaphragm surface and an outer circumference part 22 are provided. Between the inflow side block 10 and the connection block 50, the outer circumference part 22 is gripped whereby the first diaphragm 20 is fastened.

Along with interposition of the first diaphragm 20, the inflow side chamber 13 is partitioned into the two chambers of a first chamber 14 and a second chamber 15. The first chamber 14 is the section which is arranged at the inflow side chamber 13 and which contacts the controlled fluid. The second chamber 15 is the section at the back surface side of the first chamber 14, that is, the opposite surface of the first diaphragm 20, and which does not contact the controlled fluid and is the section which contacts the connection chamber 52 of the connection block 50. The second chamber 15 becomes an air chamber, so the connection block 50 is formed with a breathing path 58 which is connected to the second chamber 15.

Further, the second diaphragm 40 which forms the outflow side of the controlled fluid is interposed between the connection block 50 and the outflow side block 30. At the second diaphragm 40 as well, a thin movable film part 41 which becomes the diaphragm surface and an outer circumference part 42 are provided. Between the connection block 50 and the outflow side block 30, the outer circumference part 42 is gripped whereby the second diaphragm 30 is fastened.

Along with interposition of the second diaphragm 40, the outflow side chamber 33 is partitioned into the two chambers of a third chamber 34 and a fourth chamber 35. The third chamber 34 is the section which is arranged at the outflow side chamber 33 and which contacts the controlled fluid. The fourth chamber 35 is the section at the back surface side of the third chamber 34, that is, the opposite surface of the second diaphragm 40, and which does not contact the controlled fluid and is the section which contacts the connection chamber 52 of the connection block 50. The fourth chamber 35 also becomes an air chamber, so the connection block 50 is formed with a breathing path 59 which is connected to the fourth chamber 35.

At the inside of the connection block 50, a connection chamber 52 which runs from the second chamber 15 to the fourth chamber 35 is formed. Inside of the connection chamber 52, a transmission member 55 is housed to be able to advance and retract. The first diaphragm 20 and the second diaphragm 40 are engaged with the transmission member 55. Fluctuation of one diaphragm is directly transmitted to the other diaphragm through the transmission member 55. The illustrated transmission member 55 is a cylindrical columnar member 56 which is provided with a columnar step part 53. The engagement of the first diaphragm 20 and the transmission member 55 is abutting engagement by surface contact. By engagement of the second diaphragm 40 and the transmission member 55, the screw part 46 which is provided at the center portion of the second diaphragm 40 is screwed with the transmission member 55 and the two are mechanically connected. Therefore, the advancing and retracting motions of the second diaphragm 40 and the transmission member 55 become the same at all times.

In the case of the flow control valve 101 of the first embodiment, a spring 61 (coil spring) is provided as the biasing means (pressing means) 60 inside of the connection chamber 52. The spring 61 is inserted into the columnar step part 53 of the transmission member 55 and abuts against the block step part 51 of the connection block 50. Therefore, by the action of the biasing force (spring elasticity) of the biasing means 60 (illustrated spring 61), the transmission member 55 is pushed against the first diaphragm 20 side at all times. By employing the spring 61 as the biasing means 60, the mechanism for applying bias becomes simpler and the cost can be lowered by that amount.

The first diaphragm 20 receives the fluid pressure of the controlled fluid which flows into the first chamber 14. Further, at the same time as receiving pressure, the first diaphragm 20 presses against (biases) the first chamber 14 side by a constant force at all times by the action of the above-mentioned biasing means 60 (spring 61).

The second diaphragm 40 receives the fluid pressure of the controlled fluid which flows through the connection flow path 70 to the inside of the third chamber 34. Further, it is provided with a valve element 47 which advances and retracts with respect to a valve seat 37 which is formed at the outflow side chamber 33. The valve element 47 of the flow control valve 101 of the first embodiment is a substantially conical shaped taper and sticks out from the center part of the second diaphragm 40 in the direction of the valve seat 37. Due to the elasticity of the above-mentioned spring 61, an action arises on the valve element 47 separating it from the valve seat 37 at all times. The valve element 47 does not contact the valve seat 37 to close the valve seat opening 36, but forms a suitable clearance at all times.

Therefore, by the second diaphragm 40 (valve element 47) approaching or separating from the valve seat 37, the amount of opening of the valve seat opening 36 changes and the flow amount of the controlled fluid which passes through the valve seat opening 36 changes. Note that, the valve element 37 which is formed at the second diaphragm 40 is not limited to the illustrated shape and may also be made a columnar or other shape.

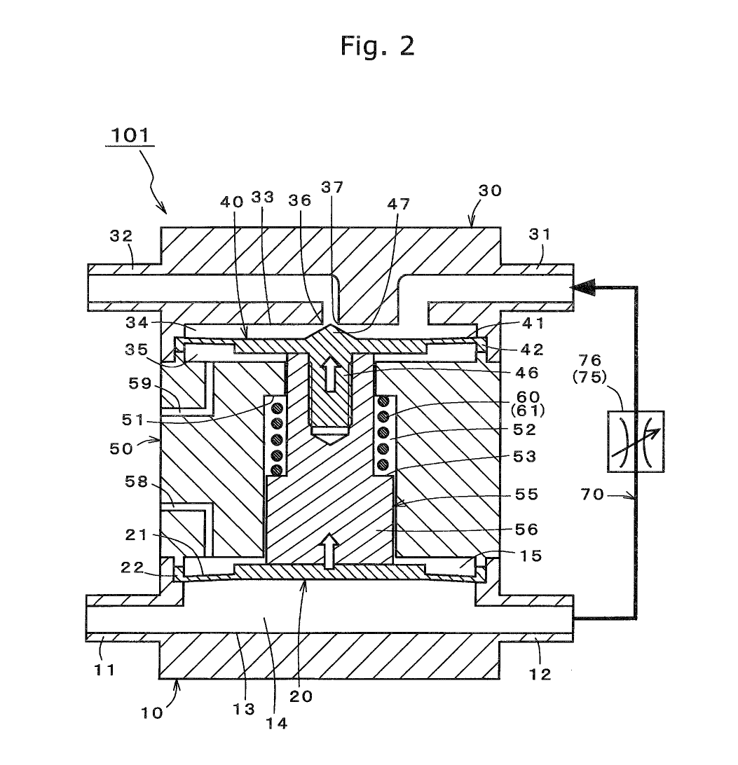

The vertical cross-sectional view of FIG. 2 shows the flow control valve 101 at the time of advance of the valve element 47. Due to the pressure rise at the primary side (upstream side) of the flow control valve 101, the fluid pressure of the controlled fluid at the first diaphragm 20 side rises. For this reason, the first diaphragm 20 retracts compared with FIG. 1. In the illustration, it rises. Linked with this action, the transmission member 55 which contacts the first diaphragm 20 also retracts. In the illustration, it moves upward. Therefore, the second diaphragm 40 which is connected with the transmission member 55 advances, and the valve element 47 which is formed at the second diaphragm 40 advances in the direction of the valve seat 37. In this way, the opening amount of the valve seat opening 36 is made smaller by the valve element 47.

The illustrated flow control valve 101 is an example where a variable orifice 76 is used for the pressure differential device part 75. The flow control valve is a valve which can change the flow amount of the fluid which is circulated to a desired flow amount region and which can stabilize it at a constant flow amount.

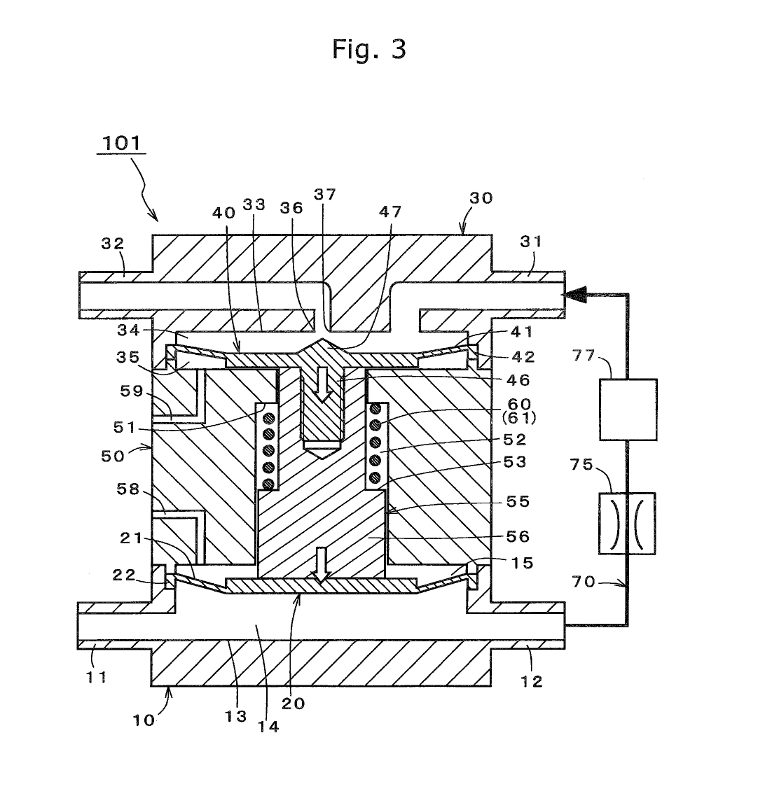

The vertical cross-sectional view of FIG. 3 shows a flow control valve 101 at the time of retraction of the valve element 47. Due to the rise in pressure at the secondary side (downstream side) of the flow control valve 101, the fluid pressure of the controlled fluid at the second diaphragm 40 side rises. In this case, at the second diaphragm 40 side, an action arises in a direction pushing back against the load from the first diaphragm 20. Therefore, the second diaphragm 40 and the transmission member 55 retract together with the valve element 47 from the valve seat 37 and the amount of opening of the valve seat opening 36 becomes greater. Further, the operation is also transmitted to the first diaphragm 20 which is engaged with the transmission member 55, so the first diaphragm 20 advances through the transmission member 55.

The flow control valve 101 of FIG. 3 is provided with a flow detecting part 77 at the connection flow path 70. The flow detecting part 77 is a known differential pressure type flowmeter, ultrasonic flowmeter, etc. For this reason, it is possible to make use of the piping of the connection flow path to streamline the layout of pipelines.

In this way, the first diaphragm 20 and the second diaphragm 40 receive the pressure fluctuation of the controlled fluid before and after the pressure differential device part 75. Further, the fluctuations which occur at the diaphragms are transmitted through the transmission member 55 to the diaphragms. As a result, the fluctuations which occur are accurately reflected in the advancing and retracting motions of the second diaphragm 40 and the valve element 47, while the valve element 47 advances and retracts with respect to the valve seat 37. Therefore, the valve lift (opening degree) of the valve seat opening 36 (opening amount) is adjusted and as a result the flow amount of the controlled fluid which passes through the flow control valve 101 is maintained at a constant flow amount.

The main members at the flow control valve 101 of the first embodiment such as the inflow side block 10, first diaphragm 20, outflow side block 30, and second diaphragm 40 are required to have the property of not being corroded by the controlled fluid or not having an effect on the cleanliness of the controlled fluid. For this reason, the main component members of the flow control valve 101 are formed by PfeE, PFA, PVDF, or other fluororesins or stainless steel or other corrosion resistant metal or combinations of the same and other materials which are high in corrosion resistance and chemical resistance. In particular, for the members of portions which contact the controlled fluid, the above resin materials are used.

The illustrated flow control valve 101 is formed by cutting from a block of a fluororesin. The flow control valves 102, 103, and 104 of the later explained second to fourth embodiments are also comprised of blocks of fluororesins similar to the flow control valve 101 in consideration of the point of not affecting the cleanliness of the controlled fluid.

Next, the relationship between the flow amount of the controlled fluid and the fluid pressure at the flow control valve 101 will be explained with reference to FIG. 1. At the time of the following explanation, the fluid pressure which is applied to the first diaphragm 20 is designated as “P1”, the fluid pressure which is applied to the second diaphragm 40 is designated as “P2”, the fluid pressure at the main outflow part 32 side which is applied to the second diaphragm 40 is designated as “P3”, the load which is applied by the biasing means 60 to the first diaphragm (spring load of spring 61 of illustrated spring) is designated as “SP”, the effective pressure receiving surface area of the first diaphragm 20 is designated as “S1”, the effective pressure receiving surface area of the second diaphragm 40 is designated as “S2”, and the surface area of the valve opening 36 of the valve seat 37 is designated as “S3”. Further, the flow amount of the controlled fluid is expressed as “Q”, a flow coefficient which is set by the valve lift surface area of the pressure differential device part 75 is expressed by “A”, and a differential pressure (P1−P2) which is caused before and after the pressure differential device part 75 is expressed as “ΔP”. Note that, the effective pressure receiving surface area S1 of the first diaphragm 20 and the effective pressure receiving surface area S2 of the second diaphragm 35 are made equal (S1=S2). Further, the effective pressure receiving surface area at a diaphragm is the surface area of the moving part, that is, the moving film part of the diaphragm surface comprised of a thin film part, which effectively receives pressure.

The force (F1) which causes the first diaphragm 20 to retract and the force (F2) which causes the second diaphragm 40 to retract are expressed by the following formulas:

F1=S1×P1

F2=(S2−S3)×P2+S3×P3+SP

Here, by making the surface area S3 of the valve seat opening 36 of the valve seat 16 very small, the fluid pressure P3 at the main outflow part 32 side which is applied to the second diaphragm 40 becomes negligible. From these, the balance formula (F1=F2) becomes as follows:

S1×P1=S1×P2+SP

S1(P1−P2)=SP

ΔP=SP/S1

As will be understood from the above formula, the differential pressure (ΔP) due to the pressure differential device part 75 of the flow control valve 101 is determined by the load (SP) of the biasing means 60 and the effective pressure receiving surface areas of the first diaphragm 20 and the second diaphragm 40 (S1=S2). Therefore, the flow amount (Q) of the fluid is determined by the differential pressure (ΔP), so can be expressed by the following formula:

$$\begin{matrix}Q = A \times √ ( Δ P ) \\ = A \times √ ( SP / S 1 )\end{matrix} \qquad ( i )$$

Therefore, at the flow control valve 101, by changing the load (SP) of the biasing means 60, it becomes possible to change the differential pressure (ΔP) and change the flow amount (Q) of the fluid. Note that, as the method for changing the amount of pressing of the biasing means 60, there are the methods of changing the spring itself to change the spring load.

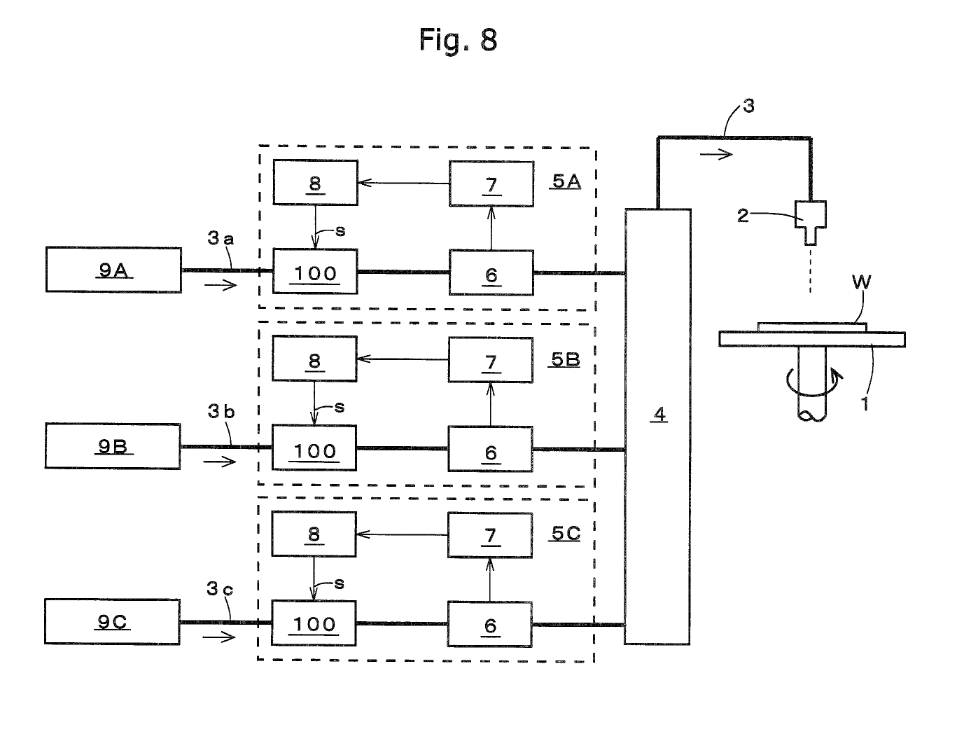

Furthermore, in the disclosed flow control valve 101 and the flow control valves of the other embodiments, a pressure differential device part 75 constituted by a variable orifice 76 which enables adjustment of the valve lift of the flow path is employed (see FIG. 2 etc.). When assuming assembly into the flow control system which is explained later in FIG. 8, control of the flow amount becomes easy. The variable orifice 76 is for better facilitating the change in flow amount of the controlled fluid. For this variable orifice 76, a known valve mechanism which can engage in an advancing and retracting motion is employed. Further, when controlling the amount of advance or retraction of the valve mechanism (not shown) of the variable orifice 76, a known stepping motor, servo motor, ultrasonic motor, etc. or pneumatic air which is supplied from an electropneumatic converter is used. The flow amount is adjusted based on a control signal from the outside.

Here, the advantage of employing a variable orifice for the pressure differential device part will be explained. The relationship between the flow amount (Q) of the fluid and the differential pressure (Q) is shown as the above-mentioned formula (i). In formula (i), when changing the differential pressure (ΔP) to try to adjust the flow amount (Q), the flow amount (Q) changes “proportionally to a square root” of the differential pressure (ΔP). For this reason, even if changing the amount of change of the differential pressure (ΔP), it is difficult to make the flow amount (Q) change by an amount commensurate with the change in the differential pressure (ΔP). Further, adjustment of the differential pressure (ΔP) is accompanied by adjustment of the spring etc., so is not necessarily simple.

However, in formula (i), the flow amount (Q) is in a simple proportional relationship with respect to the flow coefficient (A). This being so, by changing the flow coefficient (A), it is possible to effectively change the flow amount (Q). That is, the matter which corresponds to the adjustment of the flow coefficient (A) in the formula is the amount of valve lift (opening degree) of the variable orifice.

In this way, at the flow control valve, the pressure differential device part is provided with a variable orifice, so enables the flow coefficient to be relatively easily changed. Accordingly, adjustment by change in a broader range of flow amounts becomes possible. Further, adjustment of the valve lift (opening degree) of the variable orifice is controlled based on the control signal from the outside, so easy change to the targeted range of flow amounts becomes possible.

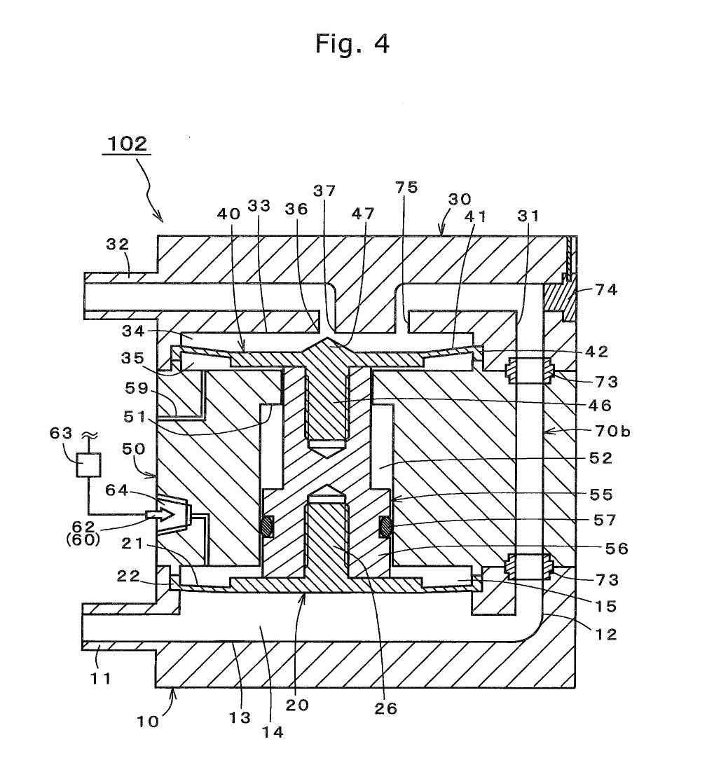

FIG. 4 is a vertical cross-sectional view of a flow control valve 102 of a second embodiment. The biasing means 60 of the flow control valve 102 of the second embodiment is pneumatic air (pressure adjusting gas) 62. The pneumatic air 62 which is supplied from the electropneumatic converter 63 (electropneumatic regulator) flows from the inlet port 64 of the connection block 50 through the connection block 50 to flow into the second chamber 15. Further, the first diaphragm 20 is pressed against from the back surface side at all times by a constant pressure to the first chamber 14 side. When using pneumatic air for the biasing means, the pressing action of the first diaphragm 20 to the first chamber 14 side can be suitably changed in accordance with the feed pressure of the pneumatic air.

To maintain the air-tightness inside the second chamber 15, packing 57 is arranged at the barrel part of the transmission member 55 (columnar member 56). Further, a screw part 26 which is provided at the center part of the first diaphragm 20 is screwed with the transmission member 55 whereby the two are mechanically connected. Therefore, the first diaphragm 20, transmission member 55, and second diaphragm 40 operate to advance and retract as one. In the figure, reference notation 73 indicates a connecting member, while 74 indicates a sealing stopper.

Furthermore, according to the flow control valve 102 of the second embodiment, a connection flow path 70b is formed at the inside of the connection block 50. The controlled fluid directly flows in from the intermediate outflow part 12 of the inflow side block 10 to the connection flow path 70b of the connection block 50 and from there flows into the intermediate inflow part 31 of the outflow side block 30. Since, in this way, no flow path outside of the flow control valve is used, the valve is excellent in terms of cleanliness. In this structure of flow control valve 102, near the terminal end of the intermediate inflow part 31, a pressure differential device part 75 is formed, so in this structure a pressure difference occurs between the first diaphragm 20 side and the second diaphragm 40 side.

Therefore, regardless of the change of the biasing means and the arrangement of the connection flow path and pressure differential device part, in the flow control valve 102 as well, the advancing and retracting operations of the first diaphragm 20 and the second diaphragm 40 are transmitted through the transmission member 55 to each other. The action of maintaining the controlled fluid constant becomes similar to that of the above-mentioned flow control valve 101.

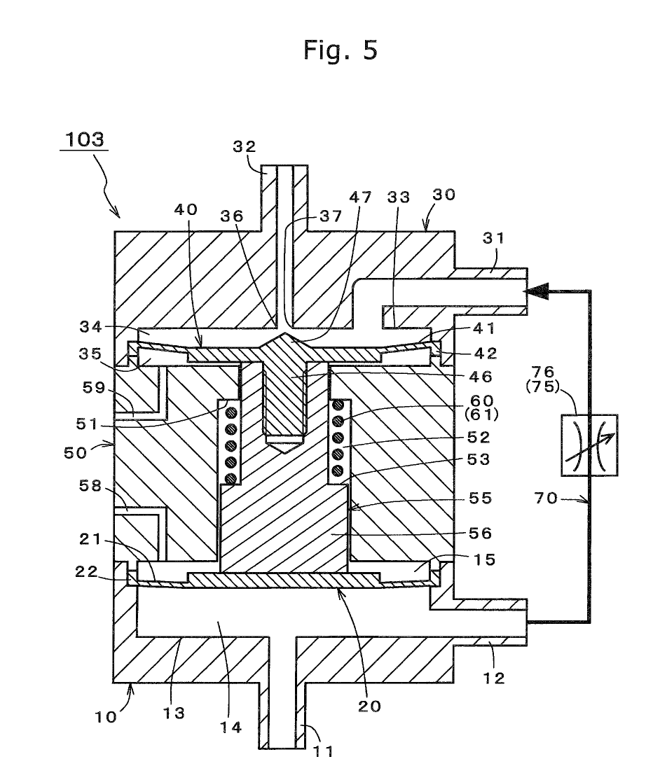

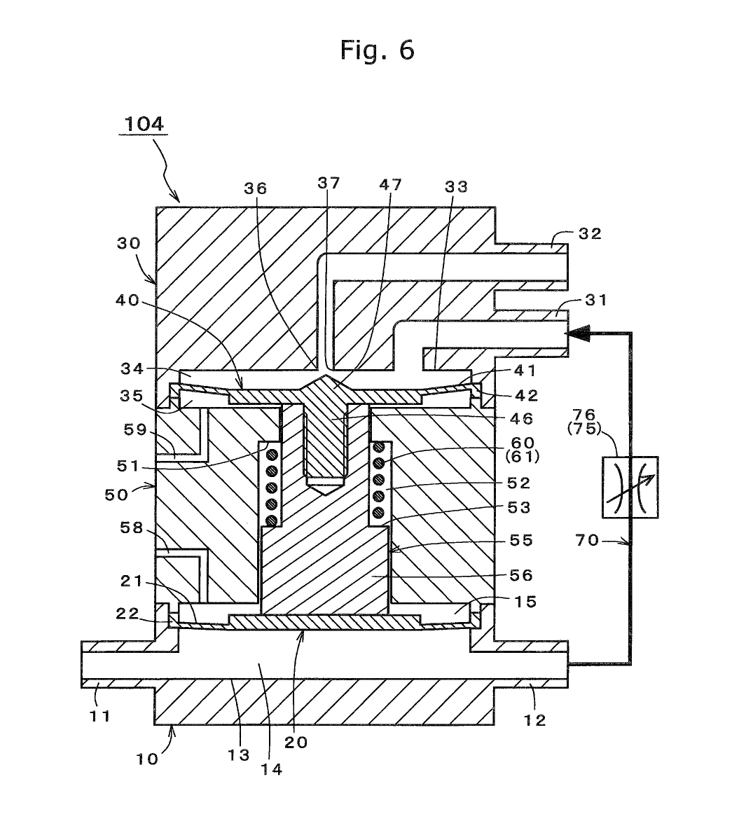

The vertical cross-sectional view of FIG. 5 shows a flow control valve 103 of a third embodiment. In the flow control valve 103, the main inflow part 11 and the main outflow part 32 of the controlled fluid are arranged on a straight line. The vertical cross-sectional view of FIG. 6 shows a flow control valve 104 of the fourth embodiment. In the flow control valve 104, the main outflow part 32 is arranged in the opposite direction from the main inflow part 11 of the controlled fluid. The main inflow part 11 and the main outflow part 32 may be arranged at the flow control valves 103 and 104 in the two embodiments in any way by machining the inflow side block 10 and outflow side block 30. For example, the orientations of the main inflow part 11 and the main outflow part 32 may be made 180° when viewed from above the flow control valve and also may be formed at 90° or another suitable angle. Therefore, design freely corresponding to the configuration of the fluid piping which connects the flow control valve becomes possible and there is no difference in performance.

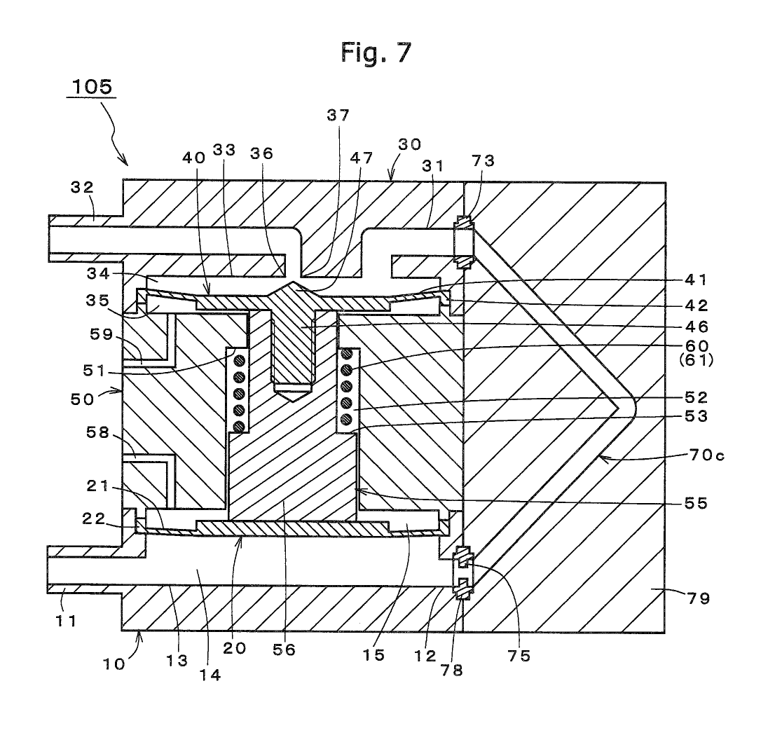

The vertical cross-sectional view of FIG. 7 shows a flow control valve 105 of a fifth embodiment. In the case of the flow control valve 105, the connection flow path 70c is formed at the inside of a flow path block 79 which is connected to the side surface of the flow control valve 105. At the time of connection, the connecting members 73 and 78 are interposed. The controlled fluid flows from the intermediate outflow part 12 of the inflow side block 10 to a V-shaped connection flow path 70c at the inside of the flow path block 79 and flows through there to the intermediate inflow part 31 of the outflow side block 30. In the flow control valve 105 of this structure, a pressure differential device part 75 is formed at the inside of the connecting member 78 which corresponds to the vicinity of the terminal end of the inflow side chamber 13 and a pressure difference arises between the first diaphragm 20 side and the second diaphragm 40 side.

In the flow control valves 101 to 105 of the first embodiment to the fifth embodiment which were illustrated up to here, the arrangements of the biasing means, pressure differential device part, flow detecting part, or main inflow part or main outflow part etc. can be suitably recombined. For example, in the flow control valve 101, the pressure differential device part can be made a variable orifice and the biasing means can be made pneumatic air. Furthermore, the flow control valve the present invention is not limited to the above embodiment. Part of the configuration can be suitably changed in a scope not departing from the gist of the invention.

Next, the flow control system of the present invention will be explained. The flow control valve which is used in that flow control system provides a variable orifice for the pressure differential device part and enables adjustment of the valve lift (opening degree) of the flow path and change of the flow amount for the variable orifice under the control of an outside signal. Below, the flow control valve 100 will be illustrated and explained. The flow control valve 100 can be obtained by selection from the flow control valves 101 to 105 of the already explained first to fifth embodiments or combinations of the same.

The schematic view of FIG. 8 shows a single wafer type substrate treatment system which treats one silicon wafer W at a time. A silicon wafer W is placed on a turntable of a spin chuck 1. Directly above the silicon wafer W, a treatment solution nozzle 2 is provided for discharging a treatment solution. Treatment solution for cleaning the silicon wafer etc. is supplied through the fluid pipe 3 to the treatment solution nozzle 2.

The treatment solution is the controlled fluid which finished being explained with reference to the flow control valve and is ultrapure water, hydrofluoric acid, hydrogen peroxide solution, ammonia water, hydrochloric acid, etc. Different controlled fluids are stored in supply parts 9A, 9B, and 9C by type and are supplied to the fluid mixing part 4 through the fluid pipes 3a, 3b, and 3c which correspond to the supply parts. The supplied controlled fluids are uniformly mixed at the fluid mixing part 4 and pass through the fluid pipe 3 to be supplied to the treatment solution nozzle 2. Further, flow control systems 5A, 5B, and 5C which control the supply of the controlled fluids, as illustrated, are connected to the pipelines of the fluid pipes 3a, 3b, and 3c between the feed parts 9A, 9B, and 9C of the controlled fluid and the fluid mixing part 4. The different flow control systems correspond to the supply parts of the controlled fluids of the different types.

Each of the flow control systems 5A, 5B, and 5C is provided with a flow control valve 100, a flow detecting part 6 of the controlled fluid, and a processing part 7. Furthermore, a control part 8 is also provided which generates signals for controlling the variable orifice which is attached to the flow control valve. The flow control valve 100, flow detecting part 6, processing part 7, and control part 8 are connected by signal lines s. Therefore, if taking the flow control system 5A as an example, the flow control valve 100 and flow detecting part 6 are connected to the fluid pipe 3a between the supply part 9A of the controlled fluid and the fluid mixing part 4 of the controlled fluid. Like in the illustrated flow control system, the number of members which contact the controlled fluid is suppressed and the cleanliness of the controlled fluid is easily maintained.

The flow detecting part 6 is a known flow meter which detects the flow amount of the secondary side (downstream side) of the flow control valve 100. For example, it is a differential pressure type flow meter, ultrasonic type flow meter, etc. Note that the flow detecting part 6 may also be set at the connection flow path 70. The processing part 7 is a microcomputer, PLC (programmable logic controller), or other known processing device. It generates signals for control of the flow amount of the flow control valve 100 in accordance with instructions from the outside or changes in the measured value of the flow meter of the controlled fluid detected by the flow detecting part 6.

The control part 8 is a pulse generator, controller, driver, etc. which is required for driving a stepping motor, servo motor, etc. for control for advancing/retracting the valve mechanism (not shown) which is provided inside the variable orifice forming the pressure differential device part. When the variable orifice advancing/retracting control is pneumatic air, the control part 8 is an electropneumatic converter. Pneumatic air which is adjusted to a predetermined pressure is supplied from the control part to a variable orifice. The control part 8 is essential for adjusting the flow amount in the variable orifice. In particular, this is important in smooth control of the amount of rotation of the motor, adjustment of the feed pressure of the pneumatic air, and other control of specific operations.

If giving an example of the flow of signals from the flow detecting part 6 to the flow control valve 100, the result generally becomes as follows: A change in the flow amount of the controlled fluid in the fluid piping is measured through the flow detecting part 6. That signal is sent to the processing part 7. The processing part 7 calculates the optimal advance/retraction position of the valve mechanism so as to obtain an optimal valve lift (opening degree) of the variable orifice. Along with this, an operating signal for motor operation in the variable orifice is generated. Further, the operating signal is sent from the processing part 7 to the control part 8. In the control part 8, specifically, a pulse signal for driving the motor is generated. This pulse signal is converted to a motor drive current. Further, the motor drive current is sent to the motor in the variable orifice, whereby the motor rotates by a limited amount. To control the amount of rotation and the position of the motor, if necessary, encoders etc. (not shown) may also be provided.

As will be understood from the flow of signals from the flow detecting part 6 to the flow control valve 100, the processing part 7 executes feedback control based on the measured value of the flow amount of the flow detecting part 6. Therefore, it is possible to immediately respond to a change in the flow amount which occurs at the secondary side (downstream side) of the flow control valve 100 to adjust the flow amount of the controlled fluid and enable a flow of controlled fluid by a constant flow amount at all times. Note that, the processing part 7 and the control part 8 may be combined to form a processing control unit.

The flow control valve which is disclosed in the present invention can realize a constant flow amount by sensitively responding to changes in pressure of the flowing fluid and, further, can maintain the cleanliness of the fluid in a higher state. Simultaneously, a function of changing the range of fluid flow amount of the controlled fluid is provided. Therefore, it is prefect for the field of semiconductor production, fuel cells, and other applications where extremely precise control of the flow amount and high cleanliness are sought.

What is claimed is:

1. A flow control valve which is provided with:
an inflow side block which is provided with a main inflow part of a controlled fluid, an inflow side chamber which is connected to said main inflow part, and an intermediate outflow part which is connected to said inflow side chamber,
an outflow side block which is provided with an intermediate inflow part, an outflow side chamber which is connected to said intermediate inflow part, a valve seat which is formed at said outflow side chamber, and a main outflow part of the controlled fluid which is connected to said outflow side chamber,
a connection block which connects said inflow side block and said outflow side block, and
a connection flow path which connects said intermediate outflow part and said intermediate inflow part, wherein
at least at one of said inflow side chamber, said outflow side chamber, and said connection flow path is provided with a pressure differential device part,
said inflow side block and said connection block have a first diaphragm interposed between them,
said first diaphragm is arranged at said inflow side chamber, divides said inflow side chamber into a first chamber which contacts the controlled fluid and a second chamber which becomes the back surface side of the first chamber and does not contact the controlled fluid, and receives the fluid pressure in said first chamber and is pressed to said first chamber side by a biasing means by a constant pressure at all times,
said outflow side block and said connection block have a second diaphragm interposed between them,
said second diaphragm is arranged at said outflow side chamber, divides said outflow side chamber into a third chamber which contacts the controlled fluid and a fourth chamber which becomes the back surface side of the third chamber and does not contact the controlled fluid, and receives the fluid pressure in said third chamber and is provided with a valve element which advances and retracts with respect to said valve seat,
said connection block has a connection chamber which runs from said second chamber to said fourth chamber, said connection chamber holding a transmission member which engages with said first diaphragm and said second diaphragm to transmit fluctuation of one diaphragm to the other diaphragm, and
advancing and retracting motion of said first diaphragm and said second diaphragm due to pressure fluctuation before and after said pressure differential device part causes said valve element to advance and retract with respect to said valve seat to hold the flow amount of the controlled fluid constant.

2. The flow control valve according to claim 1 wherein said biasing means is a spring.

3. The flow control valve according to claim 1 wherein said biasing means is pneumatic air.

4. The flow control valve according to claim 1 wherein said pressure differential device part is a variable orifice.

5. The flow control valve according to claim 1 wherein said connection flow path is provided with a flow detecting part.

6. A flow control system which is provided with the flow control valve according to claim 1, a flow detecting part of a controlled fluid, and a processing part and where the pressure differential device part of said flow control valve is a variable orifice, wherein
said flow control valve is connected to a fluid pipe between a feed part of the controlled fluid and a fluid mixing part of the controlled fluid and a control part which generates a signal which controls said variable orifice of said flow control valve is provided.

7. The flow control system according to claim 6 wherein said processing part performs feedback control based on a measured value of the flow amount of said flow detecting part.
